(19) United States
(12) Patent Application Publication
(10) Pub. No.: US 2026/0086487 A1
(43) Pub. Date: Mar. 26, 2026

(54) PAPER FEEDING DEVICE AND IMAGE FORMING APPARATUS

(71) Applicant: FUJIFILM Business Innovation Corp., Tokyo (JP)

(72) Inventor: Tetsuo NUKUI, Kanagawa (JP)

(73) Assignee: FUJIFILM Business Innovation Corp., Tokyo (JP)

(21) Appl. No.: 19/040,521

(22) Filed: Jan. 29, 2025

(30) Foreign Application Priority Data
Sep. 24, 2024 (JP) 2024-165573

(51) Int. Cl. G03G 15/00

(52) U.S. Cl. CPC G03G 15/6514; G03G 2215/00725

(57) ABSTRACT

A paper feeding device includes a regulation member that includes an abutting portion abutting a leading end of a supplied paper sheet to regulate a transportation start position of the paper sheet and of which the abutting portion moves in a transportation direction of the paper sheet and a detection unit that detects presence or absence of the paper sheet based on movement of the regulation member caused by movement of the abutting portion.

### CROSS-REFERENCE TO RELATED APPLICATIONS

This application is based on and claims priority under 35 USC 119 from Japanese Patent Application No. 2024-165573 filed Sep. 24, 2024.

### BACKGROUND

### (i) Technical Field

The present invention relates to a paper feeding device and an image forming apparatus.

### (ii) Related Art

Disclosed in JP2014-148404A is a recording medium loading device including a loading portion on which a plurality of recording mediums can be loaded and a width regulation guide that regulates and guides movement of the recording mediums loaded on the loading portion in a width direction and that is movable in the width direction. The width regulation guide includes an abutting portion that is movable in the width direction independently of movement of the width regulation guide and a first detection unit that is able to detect the amount of movement of the width regulation guide and the abutting portion includes a second detection unit that is able to detect the amount of movement of the abutting portion.

In addition, disclosed in JP1998-120245A is a paper feeding device that sequentially feeds, to an image forming apparatus, paper sheets loaded on a paper loading plate and in which whether or not the quantity of paper sheets loaded on the paper loading plate is larger than a predetermined reference quantity and the presence or absence of a loaded paper sheet are detected by the same sensor.

### SUMMARY

A paper feeding device is provided with a regulation member that regulates the position of a leading end of a paper sheet in a transportation direction and a detection member that detects the presence or absence of a paper sheet. In such a paper feeding device, a leading end of a set paper sheet abuts each of the regulation member and the detection member.

However, in a case where the size or the number of set paper sheets is small, leading ends of the paper sheets may be pushed back by the regulation member and the detection member in a case where the paper sheets are set, which may result in erroneous detection of the presence or absence of a paper sheet or a delay in transportation.

Aspects of non-limiting embodiments of the present disclosure relate to a paper feeding device and an image forming apparatus that can detect the presence or absence of a paper sheet by means of a regulation member that regulates a transportation start position of the paper sheet.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a paper feeding device including a regulation member that includes an abutting portion abutting a leading end of a supplied paper sheet to regulate a transportation start position of the paper sheet and of which the abutting portion moves in a transportation direction of the paper sheet and a detection unit that detects presence or absence of the paper sheet based on movement of the regulation member caused by movement of the abutting portion.

### BRIEF DESCRIPTION OF THE DRAWINGS

Exemplary embodiment(s) of the present invention will be described in detail based on the following figures, wherein:

FIG. 1 is a view showing an image forming apparatus according to the present exemplary embodiment;

FIG. 2 is a perspective view showing a manual feed device as seen in a direction along an arrow II of FIG. 1;

FIG. 3 is an explanatory view for description of the manual feed device in a state where there is no paper sheet supplied to a tray;

FIG. 4 is an explanatory view for description of the manual feed device in a state where a paper sheet has been supplied to the tray; and

FIG. 5 is an explanatory view for description of a modification example of a detection unit.

### DETAILED DESCRIPTION

Hereinafter, an exemplary embodiment of the present invention will be described in detail with reference to the accompanying drawings.

### Configuration of Image Forming Apparatus

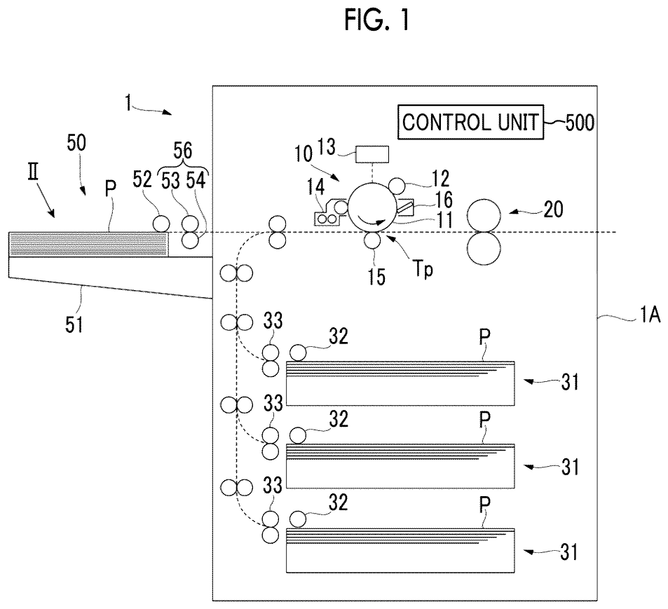

FIG. 1 is a view showing an image forming apparatus 1 according to the present exemplary embodiment. The image forming apparatus 1 is an example of a paper feeding device.

The image forming apparatus 1 includes an image forming unit 10 that forms a toner image on a paper sheet P and a fixing unit 20 that heats and presses the toner image that is formed on the paper sheet P by the image forming unit 10. In addition, the image forming apparatus 1 includes paper feed trays 31 for supply of the paper sheet P to the image forming unit 10. Furthermore, the image forming apparatus 1 includes a manual feed device 50 for supply of the specific paper sheet P, such as an envelope or a thin paper sheet, to the image forming unit 10.

The image forming unit 10 includes an image holding body 11, a charging device 12, an exposure device 13, a development device 14, a transfer device 15, and a cleaning device 16.

The image holding body 11 includes a photosensitive layer provided on an outer peripheral surface thereof and rotates in a direction along an arrow shown in FIG. 1. The charging device 12 charges the rotating image holding body 11 to a predetermined potential. The exposure device 13 selectively exposes, to light, the image holding body 11 charged by the charging device 12 such that an electrostatic latent image is formed on the image holding body 11.

The development device 14 develops the electrostatic latent image formed on the image holding body 11 with toner to form a toner image on the image holding body 11. The transfer device 15 transfers the toner image on the image holding body 11 to the paper sheet P by forming an electric field between the transfer device 15 and the image holding body 11. The cleaning device 16 removes the toner or the like remaining on the image holding body 11 after the transfer. Hereinafter, in the present specification, a position where the toner image on the image holding body 11 is transferred to the paper sheet P will be referred to as a transfer portion Tp.

Regarding the paper feed trays 31, for example, a bundle of paper sheets of a standard size such as A4 and B4 is set inside a housing 1A of the image forming apparatus 1. Meanwhile, the manual feed device 50 is used in a case where a user wants to perform printing on a paper sheet of a size that is not set in the paper feed trays 31, an envelope, a thin paper sheet, a film paper sheet, or the like. The manual feed device 50 is attached to, for example, the housing 1A to be openable and closable in a rotary manner. Details of the manual feed device 50 will be described below.

Each paper feed tray 31 includes a feeding roll 32 and a separation mechanism 33. The feeding roll 32 comes into contact with an uppermost paper sheet P among a plurality of loaded paper sheets P and feeds the uppermost paper sheet P to the separation mechanism 33. The separation mechanism 33 is composed of a feed roll that is disposed to be rotatable and a retard roll of which rotation is limited and separates the paper sheets P fed by the feeding roll 32 in an one-by-one manner. Then, the separation mechanism 33 feeds, to a downstream side, the separated paper sheets P.

The paper sheets P fed from the separation mechanism 33 are transported to the image forming unit 10 by transportation rolls provided in a paper sheet path. A registration roll is attached to the paper sheet path. The registration roll supplies, to the transfer portion Tp, the paper sheets P transported from the paper feed tray 31 or the paper sheet P fed by the manual feed device 50. The registration roll is stopped so that transportation of the paper sheet P temporarily stops in a case where the paper sheet P is transported from an upstream side. Then, the registration roll starts to rotate at a predetermined time to supply the paper sheet P to the transfer portion Tp.

The image forming apparatus 1 is further provided with a control unit 500 that controls various operations of the image forming apparatus 1. The control unit 500 in the present exemplary embodiment receives the result of detection about the presence or absence of the paper sheet P from a detection sensor 55 which will be described later and controls an image formation operation based on the result of the detection. For example, in a case where the image forming apparatus 1 detects that the paper sheet P is not present, the image forming apparatus 1 performs control to stop an image formation operation.

### Configuration of Manual Feed Device

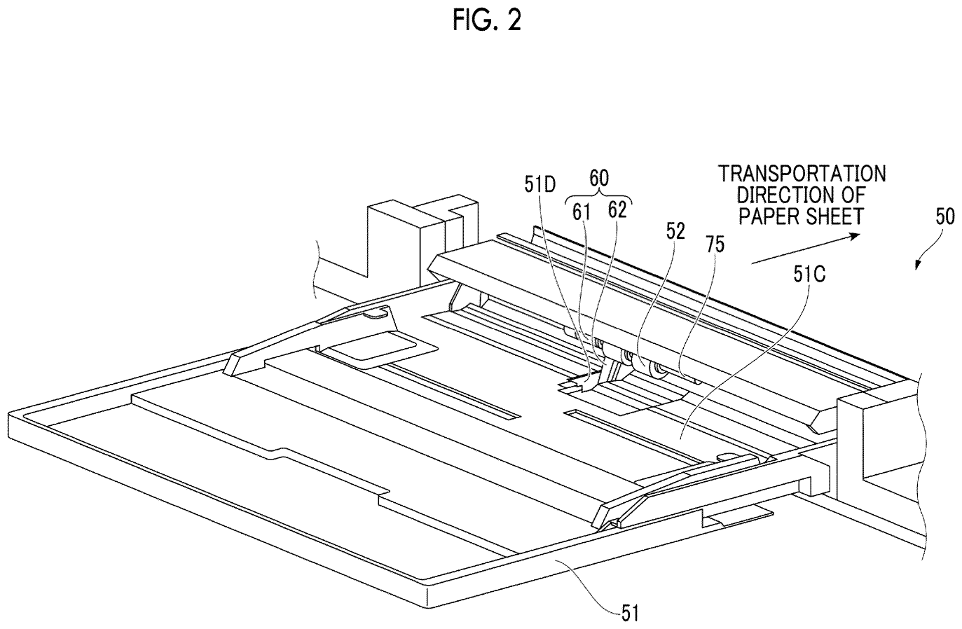

Next, the manual feed device 50 in the present exemplary embodiment will be described with reference to FIGS. 2 to 4.

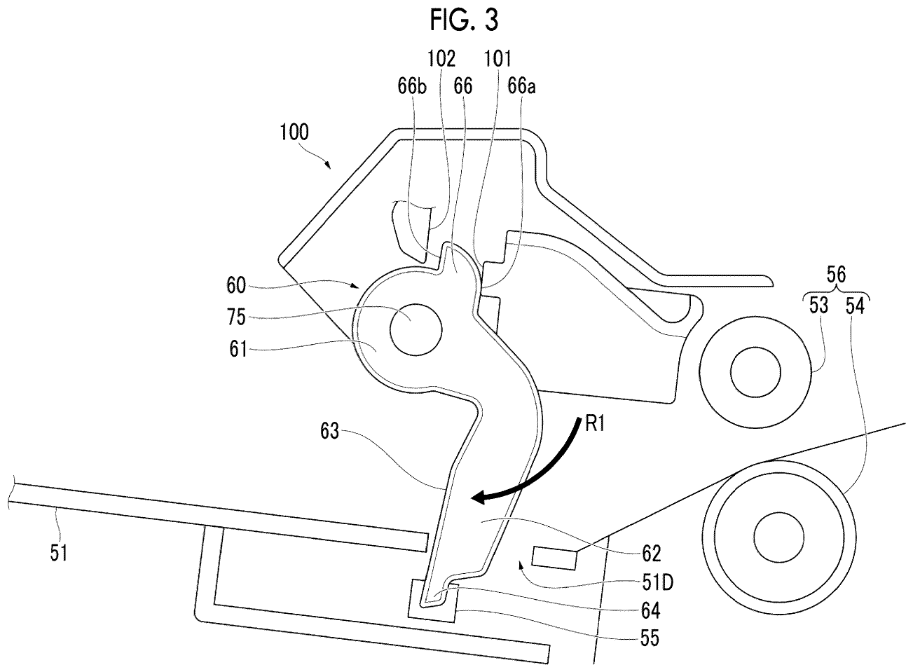

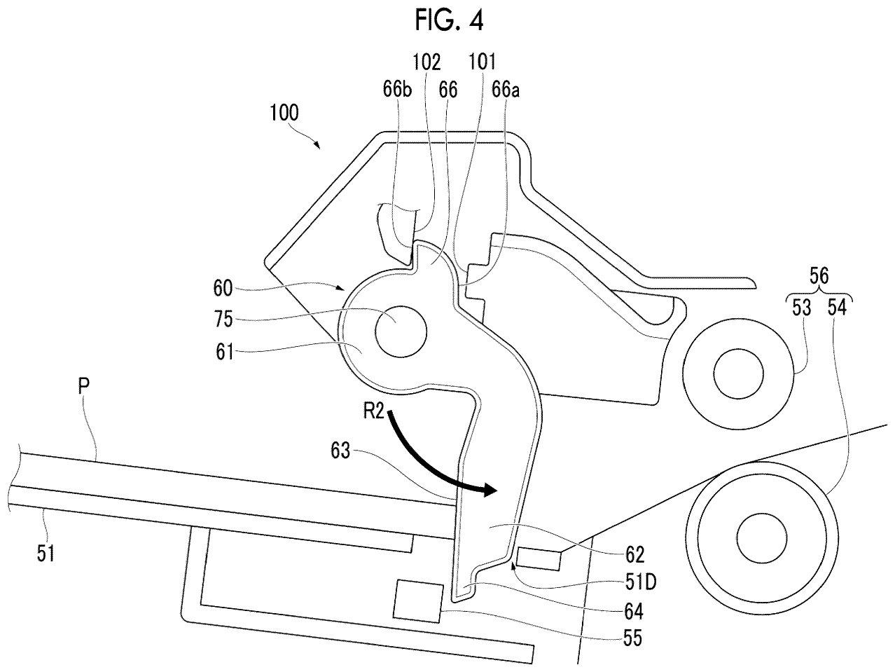

FIG. 2 is a perspective view showing the manual feed device 50 as seen in a direction along an arrow II of FIG. 1. FIG. 3 is an explanatory view for description of the manual feed device 50 in a state where there is no paper sheet P supplied to the tray 51. FIG. 4 is an explanatory view for description of the manual feed device 50 in a state where the paper sheet P has been supplied to the tray 51. FIGS. 3 and 4 show the manual feed device 50 as seen from a front surface (a front side of a paper surface in FIG. 1) of the image forming apparatus 1. In a case where the manual feed device 50 is an independent transaction target, such as a replacement component or a separately attached component, the manual feed device 50 is an example of a paper feeding device.

As shown in FIG. 2, the manual feed device 50 is provided with the tray 51 on which the paper sheet P or a bundle of the paper sheets P is placed and which serves as a transportation path along which the paper sheet P is transported. The tray 51 is an example of a paper supporting member. In addition, the manual feed device 50 is provided with a feeding roll 52 that feeds the paper sheet P supplied to the tray 51 to a separation unit 56 (refer to FIG. 3). In addition, the separation unit 56 that separates the paper sheets P fed by the feeding roll 52 in an one-by-one manner and that feeds the paper sheets P to a downstream side is provided. The separation unit 56 is composed of a feed roll 53 (refer to FIG. 3) that is disposed to be rotatable and a retard roll 54 (refer to FIG. 3) of which rotation is limited.

In addition, the manual feed device 50 is provided with a regulation member 60 that is provided on the transportation path of the paper sheet P and that regulates the position (hereinafter, may be referred to as a “transportation start position”) of a leading end of the paper sheet P in a transportation direction. In addition, the manual feed device 50 is provided with a stopping mechanism 100 that limits movement of the regulation member 60 to a certain range (refer to FIG. 3). In addition, the detection sensor 55 that detects the presence or absence of the paper sheet P based on movement of the regulation member 60 is provided. The detection sensor 55 is composed of, for example, a noncontact sensor such as an optical sensor. In addition, as the optical sensor, for example, a light-blocking type sensor or the like can be used. In addition, an upper side of the manual feed device 50 is covered with a cover member. Note that the separation unit 56 may be configured to be provided on the housing 1A side of the image forming apparatus 1.

The paper sheet P is placed on the tray 51, the tray 51 has a function as the transportation path for transportation of paper sheets, and the tray 51 is formed in a plate-like shape. The tray 51 includes a supporting surface (hereinafter, will be referred to as a “paper supporting surface 51C”) that supports the paper sheet P from below. A through-hole 51D, through which an upper side and a lower side communicate with each other with the tray 51 interposed therebetween, is formed in the paper supporting surface 51C of the tray 51.

The manual feed device 50 is provided with a rotation shaft 75 that extends in a direction orthogonal to the transportation direction of the paper sheet P to be parallel with the paper supporting surface 51C of the tray 51. The rotation shaft 75 is installed to be movable up and down with respect to the paper supporting surface 51C of the tray 51. The rotation shaft 75 is a rotation shaft of the feeding roll 52 and supports the regulation member 60. The rotation shaft 75 moves up and down to position the feeding roll 52 upward at the time of a standby period before transportation of the paper sheet P and to position the feeding roll 52 downward at the time of the transportation of the paper sheet P.

As shown in FIG. 3, the regulation member 60 includes a supporting portion 61 and an arm 62 extending from the supporting portion 61. In addition, the regulation member 60 includes an abutting surface 63 that functions as an abutting portion that the paper sheet P abuts and a detection region 64 that is a region detected by the detection sensor 55.

The supporting portion 61 supports the regulation member 60 such that the regulation member 60 is rotatable with respect to the rotation shaft 75. Accordingly, the supporting portion 61 swings around the rotation shaft 75. A projection portion 66 is formed on the supporting portion 61. The projection portion 66 is used to limit movement of the regulation member 60 to the certain range. More specifically, movement of the regulation member 60 between a state where the paper sheet P is not placed on the tray 51 and a state where the paper sheet P is placed on the tray 51 and the paper sheet P abuts the regulation member 60 up to the transportation start position is defined.

The arm 62 prompts the regulation member 60 to swing, the regulation member 60 moving due to the weight of the regulation member 60. The abutting surface 63 is formed on the arm 62, and the shape of the arm 62 has a role of determining an abutting position of the paper sheet P. In the present exemplary embodiment, the arm 62 is formed to extend in an L-shape from the supporting portion 61, and the abutting surface 63 is formed on an inner side of the L-shape. Since the abutting surface 63 is formed in such a manner, the abutting surface 63 can have a shape that extends in, for example, a direction approximately orthogonal to the paper supporting surface 51C and that is preferable for transportation of the paper sheet P in a case where a leading end of the paper sheet P abuts the abutting surface 63.

In addition, the abutting surface 63 has a certain thickness with respect to a width direction of the paper sheet P, which is a direction orthogonal to the transportation direction of the paper sheet P. Accordingly, the paper sheet P abutting the abutting surface 63 is received by a surface and the paper sheet P stably abuts the abutting surface 63. In addition, the abutting surface 63 is formed to have a certain height with respect to the paper supporting surface 51C. Accordingly, an abutting position of a bundle of the paper sheets P of which the number does not exceed a predetermined number is determined. That is, even in a case where a plurality of paper sheets P are supplied to the tray 51, an uppermost paper sheet P and a lowermost paper sheet P are supported with respect to the abutting surface 63 at the substantially same angles and the degree to which the paper sheets P are positionally offset from each other in a case where the paper sheets P are set may be reduced.

The detection region 64 is a target region to be detected by the detection sensor 55, and is provided on a line extending from the arm 62 in the present exemplary embodiment. In the case of the regulation member 60 in the present exemplary embodiment, the abutting surface 63 is formed above the through-hole 51D formed in the tray 51 and the detection region 64 is formed below the through-hole 51D. In other words, the abutting surface 63 of the regulation member 60 is formed on the transportation path and the detection region 64 is formed on a side opposite to the abutting surface 63 with the tray 51 interposed therebetween.

In addition, it can also be said that the regulation member 60 includes the detection region 64 provided on a side opposite to the rotation shaft 75 with respect to the arm 62. In addition, in the present exemplary embodiment, it can also be said that the regulation member 60 includes the detection region 64 provided at a position offset from the transportation path of the paper sheet P.

As shown in FIG. 3, in the manual feed device 50 of the present exemplary embodiment, the stopping mechanism 100 that limits movement of the regulation member 60 to the certain range is formed including a position where the supporting portion 61 at an upper portion of the regulation member 60 is formed. The stopping mechanism 100 includes the projection portion 66 formed at the supporting portion 61 and includes a first abutting wall 101 and a second abutting wall 102 that comes into contact with the projection portion 66. In a case where the paper sheet P is fed by the feeding roll 52, the second abutting wall 102 withdraws to a position where movement of the regulation member 60 is not hindered.

The projection portion 66 includes a first surface 66a that comes into contact with the first abutting wall 101 and a second surface 66b that comes into contact with the second abutting wall 102. With the first surface 66a of the projection portion 66 coming into contact with the first abutting wall 101, the position of the regulation member 60 before the setting of the paper sheet P is determined. In addition, with the second surface 66b of the projection portion 66 coming into contact with the second abutting wall 102, the position of the regulation member 60 after the setting of the paper sheet P is determined.

### Movement of Regulation Member

Next, movement of the regulation member 60 will be described with reference to FIGS. 3 and 4.

As shown in FIG. 3, in a state before paper setup where there is no paper sheet P supplied, movement of the regulation member 60 in a clockwise direction R1 shown in FIG. 3, which is caused by the weight of the regulation member 60, is regulated since the first surface 66a of the projection portion 66 comes into contact with the first abutting wall 101. Accordingly, the abutting surface 63 of the regulation member 60 is set at a position before paper setup at which a user can set the paper sheet P. In addition, in a case where the detection sensor 55 is composed of an optical sensor including a light emitting unit and a light receiving unit, light from the light emitting unit is in a state of being blocked by, for example, the detection region 64 at the position of the regulation member 60 in the state before paper setup.

In a case where the light from the light emitting unit is in a state of being blocked by the detection region 64, the detection sensor 55 detects that the paper sheet P is not present.

As shown in FIG. 4, in a paper setup state where the paper sheet P has been supplied, the regulation member 60 in a state as shown in FIG. 3 rotationally moves in a direction along a counterclockwise direction R2 since the inserted paper sheet P abuts the abutting surface 63 and the abutting surface 63 is pressed. In this case, the second surface 66b of the projection portion 66 of the regulation member 60 comes into contact with the second abutting wall 102, and thus the rotational movement of the regulation member 60 is stopped. Accordingly, the abutting surface 63 of the regulation member 60 is set at the transportation start position of the paper sheet P. In addition, in a case where the detection sensor 55 is composed of an optical sensor including a light emitting unit and a light receiving unit, light from the light emitting unit is in a state of being not blocked by the detection region 64 at the position of the regulation member 60 in the paper setup state.

In a case where the light from the light emitting unit is in a state of being not blocked by the detection region 64, the detection sensor 55 detects that the paper sheet P is present.

Thereafter, in a case where an instruction to start transportation of the paper sheet P supplied to the tray 51 is issued, the rotation shaft 75 moves downward. The feeding roll 52 comes into contact with the paper sheet P as the rotation shaft 75 moves downward. In addition, the supporting portion 61 of the regulation member 60 also moves downward as the rotation shaft 75 moves downward. As the supporting portion 61 moves downward, the second surface 66b of the projection portion 66 is separated from the second abutting wall 102 and the regulation member 60 becomes rotatable in a counterclockwise direction.

Then, the feeding roll 52 rotates and thus the paper sheet P is transported. In this case, the regulation member 60 is allowed to rotate in the counterclockwise direction, the paper sheet P moves while pressing the abutting surface 63 of the regulation member 60, and the paper sheet P moves to the separation unit 56 consisting of the feed roll 53 and the retard roll 54. Thereafter, the paper sheets P separated in an one-by-one manner by the feed roll 53 and the retard roll 54 are moved to the downstream side.

Note that regarding detection performed by the above-described detection sensor 55, light from the light emitting unit is blocked by the detection region 64 in a state where there is no paper sheet P supplied and light from the light emitting unit is not blocked by the detection region 64 in a state where the paper sheet P has been supplied. However, the detection performed by the detection sensor 55 may be performed in an opposite way. That is, a configuration may also be adopted in which light from the light emitting unit is not blocked by the detection region 64 in a state where there is no paper sheet P supplied and light from the light emitting unit is blocked by the detection region 64 in a state where the paper sheet P has been supplied.

In the present exemplary embodiment, since the regulation member 60 includes the detection region 64 in such a manner, the presence or absence of the paper sheet P may be detected by means of the regulation member 60.

### Modification Example of Detection Unit

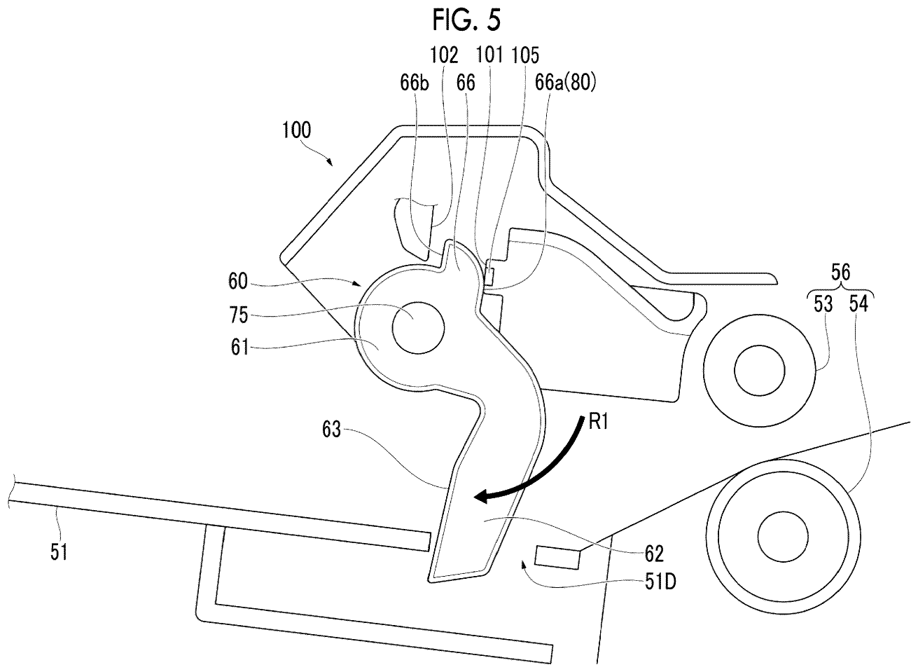

Next, a modification example of a structure shown in FIGS. 3 and 4 will be described with reference to FIG. 5.

In the example shown in FIGS. 3 and 4, the presence or absence of the paper sheet P is detected by detecting the detection region 64 of the regulation member 60, which is formed on the line extending from the arm 62, with the optical sensor. On the other hand, in the modification example, the detection region 64 is not provided at a position to which the arm 62 of the regulation member 60 is extended and another position on the regulation member 60 is detected for detection of the presence or absence of the paper sheet P.

Note that the same reference numerals are used for the same configurations as in the structure described above, and the detailed description thereof will be omitted here.

FIG. 5 is an explanatory view for description of the modification example of the detection unit.

In this modification example, the first surface 66a of the projection portion 66 functions as a detection region 80 in the modification example. In addition, in this modification example, a detection sensor 105 that detects the detection region 80 is provided at the first abutting wall 101 of the stopping mechanism 100. As the detection sensor 105 in the modification example, for example, a sensor that detects contact can be used.

As shown in FIG. 5, in a state before paper setup where there is no paper sheet P supplied, movement of the regulation member 60 in the clockwise direction R1, which is caused by the weight of the regulation member 60, is regulated since the first surface 66a of the projection portion 66 comes into contact with the first abutting wall 101. The abutting surface 63 of the regulation member 60 is set at a position before paper setup at which a user can set the paper sheet P. In this case, the first surface 66a of the projection portion 66 is in a state of being in contact with the first abutting wall 101. That is, the detection region 80 is in a state of being in contact with the detection sensor 105.

In this modification example, in a case where the detection region 80 is in a state of being in contact with the detection sensor 105, the detection sensor 105 detects that the paper sheet P is not present.

In a case where the paper sheet P is supplied, the regulation member 60 rotationally moves in a counterclockwise direction (a direction opposite to the clockwise direction R1) since the paper sheet P abuts the abutting surface 63 and the abutting surface 63 is pressed. Then, the second surface 66b of the projection portion 66 of the regulation member 60 comes into contact with the second abutting wall 102, and thus the rotational movement of the regulation member 60 is stopped. Accordingly, the abutting surface 63 of the regulation member 60 is set at the transportation start position of the paper sheet P. In this case, the first surface 66a of the projection portion 66 is in a state of not being in contact with the first abutting wall 101. That is, the detection region 80 is in a state of not being in contact with the detection sensor 105.

In this modification example, in a case where the detection region 80 is in a state of not being in contact with the detection sensor 105, the detection sensor 105 detects that the paper sheet P is present.

In the modification example, the first surface 66a of the projection portion 66 functions as the detection region 80, and the presence or absence of the paper sheet P is detected based on whether or not the first surface 66a is in contact with the detection sensor 105. Meanwhile, an opposite surface of the projection portion 66 may function as the detection region 80. That is, the second surface 66b of the projection portion 66 functions as the detection region 80. In this case, the detection sensor 105 is provided at the second abutting wall 102. Then, whether or not the second surface 66b is in contact with the detection sensor 105 is detected for detection of the presence or absence of the paper sheet P.

In the modification example shown in FIG. 5, a contact sensor is adopted as the detection sensor 105. However, the present invention is not limited thereto. An optical sensor including a light emitting unit and a light receiving unit may also be adopted as the detection sensor 105. In this case, the detection sensor 105 is provided, for example, at a position above the supporting portion 61 at which a change in position of the projection portion 66 formed on the supporting portion 61 can be detected. In addition, the detection sensor 105 detects the presence or absence of the paper sheet P based on whether or not light from the light emitting unit is in a state of being blocked by the projection portion 66. In this case, it can be said that the projection portion 66 functions as the detection region 80.

Even in the case of this modification example, the presence or absence of the paper sheet P may be detected by means of the regulation member 60 since the regulation member 60 includes the detection region 80. In addition, in this modification example, the arm 62 does not need to extend to a position below the tray 51.

Although the exemplary embodiment of the present invention has been described above, the technical scope of the exemplary embodiment of the present invention is not limited to the above exemplary embodiment. The exemplary embodiment of the present invention is not limited to a manual feed device and can be applied to, for example, an auto document feeder (ADF) that automatically feeds, to an image reading unit, paper sheets supplied thereto in an one-by-one manner. In addition, various modifications and alternative configurations are involved in the present invention without departing from the technical scope of the present invention.

### Supplementary Note

(((1)))

A paper feeding device comprising:
a regulation member that includes an abutting portion abutting a leading end of a supplied paper sheet to regulate a transportation start position of the paper sheet and of which the abutting portion moves in a transportation direction of the paper sheet; and a detection unit that detects presence or absence of the paper sheet based on movement of the regulation member caused by movement of the abutting portion.
   (((2)))

The paper feeding device according to (((1))),
wherein the detection unit detects the presence or absence of the paper sheet by recognizing the movement of the regulation member with a noncontact sensor.
   (((3)))

The paper feeding device according to (((2))),
wherein the regulation member is supported by a rotation shaft on one end side, includes the abutting portion provided on the other end side, and swings around the rotation shaft in a case where the paper sheet abuts the abutting portion, and
the noncontact sensor detects the presence or absence of the paper sheet based on a change in position of the swinging regulation member.
   (((4)))

The paper feeding device according to (((3))),
wherein the regulation member includes a detection region that is provided on a side opposite to the rotation shaft with respect to the abutting portion and that is detected by the noncontact sensor.
   (((5)))

The paper feeding device according to any one of (((1))) to (((4))),
wherein the regulation member includes a detection region that is provided at a position offset from a transportation path, through which the paper sheet is transported, and that is a target to be detected by the detection unit.
   (((6)))

The paper feeding device according to (((5))), further comprising:
a paper supporting member that supports the supplied paper sheet from below,
wherein the detection region is positioned below the paper supporting member.
   (((7)))

An image forming apparatus comprising:
the paper feeding device according to any one of (((1))) to (((6))).

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A paper feeding device comprising:
a regulation member that includes an abutting portion abutting a leading end of a supplied paper sheet to regulate a transportation start position of the paper sheet and of which the abutting portion moves in a transportation direction of the paper sheet; and
a detection unit that detects presence or absence of the paper sheet based on movement of the regulation member caused by movement of the abutting portion.

2. The paper feeding device according to claim 1,
wherein the detection unit detects the presence or absence of the paper sheet by recognizing the movement of the regulation member with a noncontact sensor.

3. The paper feeding device according to claim 2,
wherein the regulation member is supported by a rotation shaft on one end side, includes the abutting portion provided on the other end side, and swings around the rotation shaft in a case where the paper sheet abuts the abutting portion, and
the noncontact sensor detects the presence or absence of the paper sheet based on a change in position of the swinging regulation member.

4. The paper feeding device according to claim 3,
wherein the regulation member includes a detection region that is provided on a side opposite to the rotation shaft with respect to the abutting portion and that is detected by the noncontact sensor.

5. The paper feeding device according to claim 1,
wherein the regulation member includes a detection region that is provided at a position offset from a transportation path, through which the paper sheet is transported, and that is a target to be detected by the detection unit.

6. The paper feeding device according to claim 5, further comprising:
a paper supporting member that supports the supplied paper sheet from below,
wherein the detection region is positioned below the paper supporting member.

7. An image forming apparatus comprising:
the paper feeding device according to claim 1.

8. An image forming apparatus comprising:
the paper feeding device according to claim 2.

9. An image forming apparatus comprising:
the paper feeding device according to claim 3.

10. An image forming apparatus comprising:
the paper feeding device according to claim 4.

11. An image forming apparatus comprising:
the paper feeding device according to claim 5.

12. An image forming apparatus comprising:
the paper feeding device according to claim 6.
